(19) United States
(12) Patent Application Publication
(10) Pub. No.: US 2015/0235408 A1
(43) Pub. Date: Aug. 20, 2015

(54) Parallax Depth Rendering

(71) Applicant: Apple Inc., Cupertino, CA (US)

(72) Inventors: Kevin A. Gross, San Francisco, CA (US); Richard L. Baer, Cupertino, CA (US); Damien J. Thivent, Santa Clara, CA (US)

(73) Assignee: Apple Inc., Cupertino, CA (US)

(21) Appl. No.: 14/181,343

(22) Filed: Feb. 14, 2014

(51) Int. Cl. G06T 15/00; G06T 7/00; G06T 3/00

(52) U.S. Cl. CPC G06T 15/005; G06T 3/0006; G06T 7/0022

(57) ABSTRACT

A pseudo-three dimensional image may be created from a two dimensional image by segmenting the two dimensional image, adjusting the scale of individual segments of the two dimensional image, then superimposing the scaled segment as layers of the pseudo-three dimensional image. By detecting changes in relative orientation of an observer and a programmable device displaying the pseudo-three dimensional image, then translating the scaled segments according to the orientation change, parallax effects may be simulated, enhancing the view of the pseudo-three dimensional image.

### BACKGROUND

This disclosure relates generally to the field of image processing. More particularly, but not by way of limitation, it relates to a technique for providing a pseudo-three-dimensional (3D) dynamic rendering of an image on a two-dimensional (2D) display.

A conventional display device (for example, MacBook Pro®, iPad®, iPhone®, and iMac® programmable devices) (“MACBOOK PRO,” “IPAD,” “IPHONE,” and “IMAC” are registered trademarks of Apple Inc.) renders 2D images that are well suited for displaying images that have been captured with conventional cameras that create 2D images.

However, the world is not a 2D world, but a 3D world. Having a technique for generating a pseudo-3D view of 2D images would be useful.

### BRIEF DESCRIPTION OF THE DRAWINGS

FIG. 1 is a block diagram illustrating an example of a simulated three-dimensional image at two orientations according to one embodiment.

FIG. 2 is a block diagram illustrating a programmable device in which the disclosed techniques may be implemented according to one embodiment.

FIG. 3 is a block diagram illustrating a network infrastructure in which the disclosed techniques may be implemented according to one embodiment.

FIG. 4 is screenshot of a pseudo three-dimensional image generated by an implementation of the disclosed techniques, with an orientation centered on the image.

FIG. 5 is a depth map for use in generating a simulated three-dimensional image according to one embodiment.

FIG. 6 is a screenshot of the pseudo three-dimensional image of FIG. 4 from a first alternate orientation.

FIG. 7 is a screenshot of the pseudo three-dimensional image of FIG. 4 from a second alternate orientation.

FIG. 8 is a flowchart illustrating a technique for generating a pseudo three-dimensional image according to one embodiment.

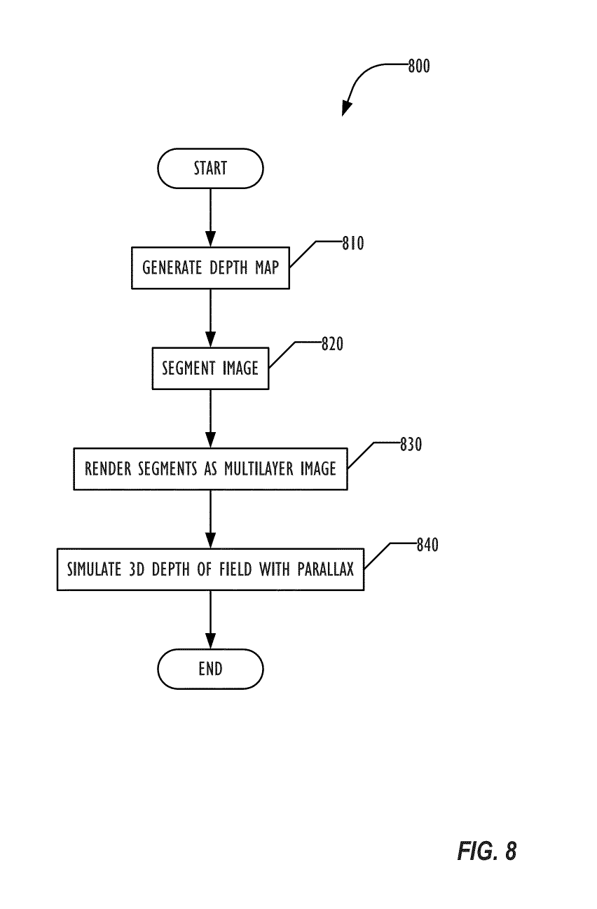

FIG. 9 is a flowchart illustrating a technique for reorienting a view of a pseudo three-dimensional object according to one embodiment.

### DETAILED DESCRIPTION

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

References to “a medium” on which are stored software for causing a programmable device to perform the techniques described below should be understood to encompass multiple physical media. Similarly reference to a programmable control unit that executes the software should be understood to encompass execution of the software by multiple programmable control units.

A technique is presented below for rendering still images and videos that enable a conventional 2D display to give an observer the appearance that the 2D display is actually a window into a 3D world. This technique is referred to herein as “depth rendering.” The depth rendering is accomplished by simulating the physical imaging characteristics of parallax and depth of field. The depth rendering typically employs three inputs: 1) an input image or video; 2) a way to segment the input image into 2 or more distinct regions; and 3) relative orientation information between the display and the observer.

Depth rendering is a dynamic rendering of an image on a 2D display that changes as the observer adjusts their orientation (spatial-relationship) with the device in real time. By segmenting an image into 2 or more different regions the regions can be parameterized and then numerically altered to simulate the effect of viewing a 3D scene. More specifically, depth rendering employs a simulation of parallax and a simulation of depth of field.

The parameters of an image segment that can be altered to create the parallax effect include (but are not limited to) the position, scale, rotation, perspective and distortion of the image segment. The parameters of an image segment that can be altered to create the depth of field effect include (but are not limited to) the blur, sharpness, scale, position, rotation, color, contrast, saturation, hue and luminance of the image segment. In some embodiments, the depth rendering may modify parameters of less than all of the image segments.

Depth rendering involves rendering the various image segments as separate planes that are then superimposed on top of each other. Conceptually the superimposition can be visualized as a vertical stack of image segments ordered by increasing depth from top to bottom of the stack such that segments near the top of the stack may or may not occlude segments near the bottom of the stack. A given image segment is changed by altering one or more of the parameters of the segment. The change in the segment affects the occlusion of the image segments below the given image segment in the stack, which in turn simulates the effect of parallax and or depth of field. By coupling the parameters of the image segments to the relative observer-display orientation data, the effects of parallax and depth of field can be simulated in real time to create a user experience that mimics viewing a 3D scene.

In addition to image segment processing based on relative orientation information, depth rendering can also employ for each image segment conventional image processing effects such as color changes, contrast, hue, saturation or any other image filtering technique for creative or artistic effect. For example, in one embodiment, a specific image segment's saturation or contrast may be adjusted relative to the other image segments to draw the observer's attention to that segment.

The parallax simulation and the depth of field simulation can be controlled automatically based on available orientation data or programmatically by other user input, such as controls of a user interface (UI).

When the input image is a conventional 2D image and a coarse depth map is provided, the input image can be segmented by depth into N separate regions. Since the input image is a conventional 2D image and not a model of a 3D scene, the effect of parallax needs to be approximated and cannot be inferred from the available data. To that end, the scale of the segments may be increased monotonically with stack position with largest scale at the top of the stack. The parallax effect can then be simulated by translating position of the segments relative to each other within the stack as a function of the relative orientation.

In one embodiment, monotonically increasing a scaling parameter for the segments in the stack ensures that all image segments in the stack will necessarily occlude some portions of the neighboring lower segments in the stack. In this embodiment a larger scale parameter implies that the image segment occupies a larger area of the image. In an embodiment where a larger scale parameter indicates the image segment occupies a smaller area of the image, the scaling parameter may be monotonically decreased. The amount of occlusion determines the extent of the parallax effect that can be achieved, with the larger the amount of occlusion, the larger the extent of the parallax effect can be achieved.

For example, if the user moves his/her head to the right (with respect to the display) or if the user turns the device to the left (with respect to the observer's face) then the image segments are to be translated to the left in the rendered image such that the observer perceives the effect of “looking behind” the closer image segments in the stack. In this example, the amount of translation to be applied monotonically increases with stack position such that the segments at the top of the stack (closest) receive the largest translation and the segment at the bottom of the stack receives no translation at all. In some embodiments, movement of the user's head may include turning the head, in addition to or instead of translational movement of the head. One of skill in the art will recognize that either movement of the user or movement of the device (or both) may occur to cause a change in the relative position and orientation of the user and the device.

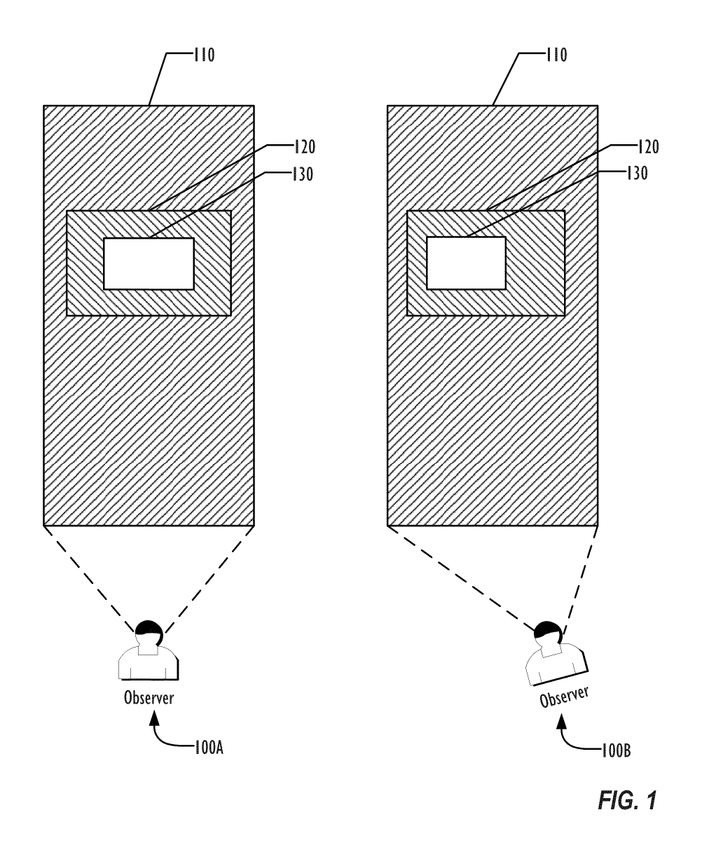

FIG. 1 is a block diagram illustrating a 2D image with stacked segments according to one embodiment at two different observer positions 100A and 100B. In this example, background image segment 110, mid-ground segment 120, and foreground segment 130 are illustrated. For clarity, only 3 segments are illustrated in this example, but any number of image segments may be used.

In observer position 100A, the observer is effectively looking straight on to the rendered image, and background segment 110, mid-ground segment 120, and foreground segment 130 are stacked centered horizontally. Now the observer moves to position 100B to the right side of the image (or the image moves to the left). As illustrated in FIG. 1, the mid-ground segment 120 and foreground segment 130 appear to have moved leftwards on background segment 110, and the foreground object appears to have moved leftwards on mid-ground segment 120, as they would if the mid-ground and foreground segments 120, 130 were actual 3D objects floating above background segment 110. Although not illustrated in this example, translating the mid and fore-ground segments 120, 130 to the right instead of left could be used to make the mid- and foreground segments 120, 130 appear to be floating behind the background segment 110, giving an illusion of depth behind the background image 110, instead of depth above the background image 110. The parallax effect created by movement (or orientation change) of the observer in such an embodiment thus makes the image appear to be a 3D image, even though the actual display is a 2D display.

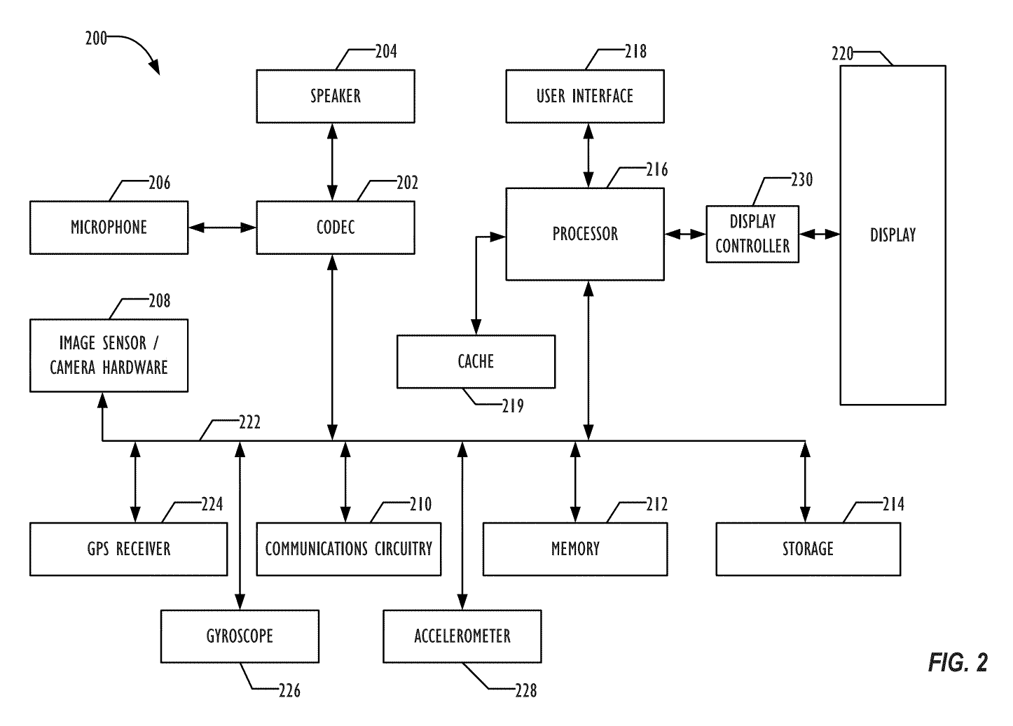

FIG. 2 shows one example of a programmable device 200 that can be used with one embodiment to implement the techniques disclosed herein. While FIG. 2 illustrates various components of a computer system, it is not intended to represent any particular architecture or manner of interconnecting the components as such details are not germane to the present disclosure. Network computers and other data processing systems (for example, handheld computers, personal digital assistants (PDAs), cellular telephones, entertainment systems, consumer electronic devices, etc.) which have fewer components or perhaps more components may also be used to implement one or more embodiments.

As shown in FIG. 2, the programmable device 200, which is a form of a data processing system, includes an interconnect 222 that is coupled to one or more programmable control units 216, which may be one or more central processing units (CPUs) and/or graphics processing units (GPUs), a memory 212, which may include one or both of a volatile read/write random access memory (RAM) and a read-only memory (ROM), and a non-volatile storage device 214. Various embodiments of the programmable control units 216 may also include one or more local memories, not shown for clarity. The programmable control unit(s) 216 may retrieve instructions from the memory 212 and the storage device 214 and execute the instructions using cache 218 to perform operations described below. The interconnect 222 interconnects these various components together and also interconnects these components 216, 218, 212, and 214 to a display controller 230 and display device 220. A codec 202 may allow connection to audio devices such as speaker 204 and microphone 206. Where volatile RAM is included in memory 212, the RAM is typically implemented as dynamic RAM (DRAM) which requires power continually in order to refresh or maintain the data in the memory. The display controller 230 and display device 220 may optionally include one or more GPUs to process display data.

The storage device 214 is typically a magnetic hard drive, an optical drive, a non-volatile solid-state memory device, or other types of memory systems which maintain data (e.g. large amounts of data) even after power is removed from the system. While FIG. 2 shows that the storage device 214 is a local device coupled directly to the rest of the components in the data processing system, embodiments may utilize a non-volatile memory which is remote from the system, such as a network storage device which is coupled to the data processing system through a communications circuitry 210 that provides a network interface and other communication functionality, including a wired or wireless networking interface. The interconnect 222 may include one or more interconnects connected to each other through various bridges, controllers and/or adapters as is well known in the art. Although only a single element of each type is illustrated in FIG. 2 for clarity, multiple elements of any or all of the various element types may be used as desired.

Positioning circuitry such as a Global Positioning System (GPS) receiver 224 may be used to determine the position of the programmable device 100. Similarly, a gyroscope 226 and accelerometer 228 or other motion and rotation-sensing circuitry may provide information to determine the position, movement, and orientation of the programmable device 100. An image sensor 208, such as a camera, may also provide a way for the programmable device 100 to determine the position and orientation of a user relative to the programmable device 100.

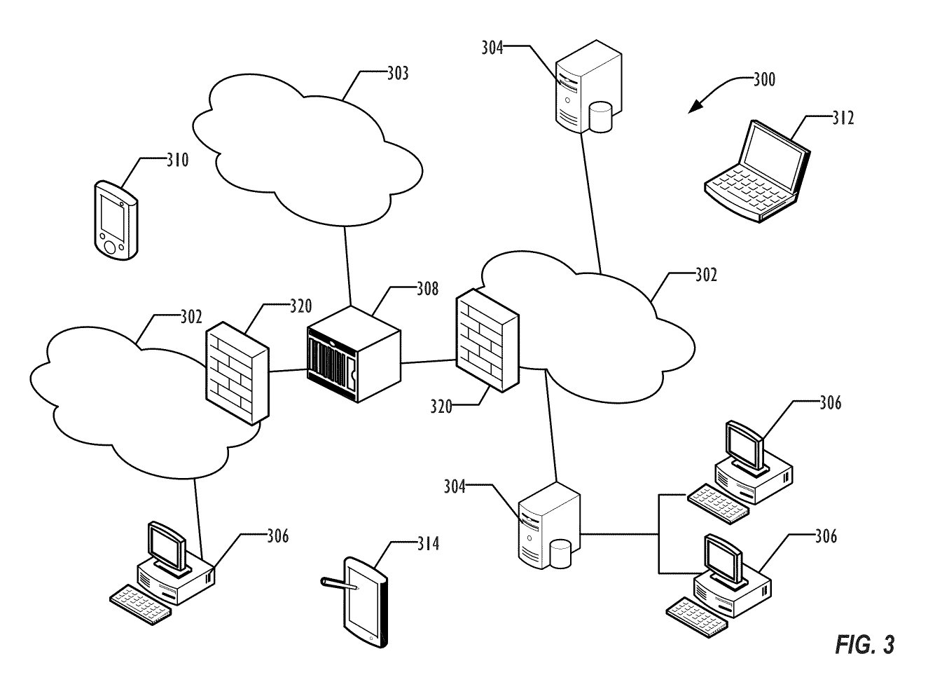

Referring now to FIG. 3, an example infrastructure 300 in which the techniques described below may be implemented is illustrated schematically. Infrastructure 300 contains computer networks 302. Computer networks 302 may include many different types of computer networks available today, such as the Internet, a corporate network, or a Local Area Network (LAN). Each of these networks can contain wired or wireless programmable devices and operate using any number of network protocols (e.g., TCP/IP). Networks 302 may be connected to gateways and routers (represented by 308), end user computers 306, and computer servers 304. Firewalls 320 may be used to secure access to the computer networks 302. Infrastructure 300 also includes cellular network 303 for use with mobile communication devices. Mobile cellular networks support mobile phones and many other types of devices. Mobile devices in the infrastructure 300 are illustrated as mobile phones 310, laptops 312, and tablets 314.

The depth rendering techniques described herein can work with any image that can be segmented. For example, this image may be a conventional 2D image captured by a single camera, a stereo image captured with 2 or more 2D cameras, or even a synthetically rendered image (2D or 3D).

Although generally described herein as employing segmentation based on depth (in terms of distance from the observer), any segmentation technique may be used as desired. When a depth map is available, the image may be segmented into regions based on a depth ordering of the segments. The segmentation used for depth rendering may be as coarse as segmenting the 2D image into as few as 2 regions. Alternately, any number of regions may be used as desired and as may be constrained by the practical computational limits imposed by the programmable device used to implement the techniques described herein.

Similarly, the size and position, rotation, perspective, and relative orientation of the image segments in the output image of the depth rendering may be calculated from any available relative orientation data, and depending on what relative orientation data is available, different effects may be applied to the depth rendering.

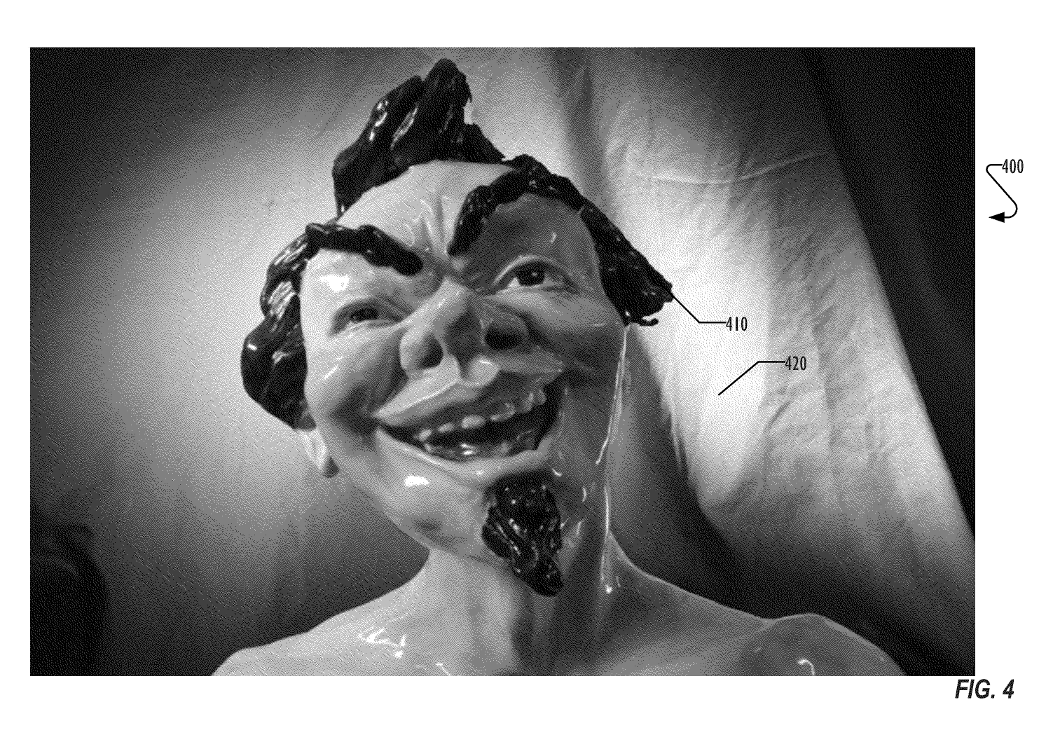

FIG. 4 is a photograph 400 of a 3D object 410 posed in front of a background 420. The photo 400 is used in the following discussion of the depth rendering techniques disclosed herein. In this view, the observer is positioned directly in front of the object 410.

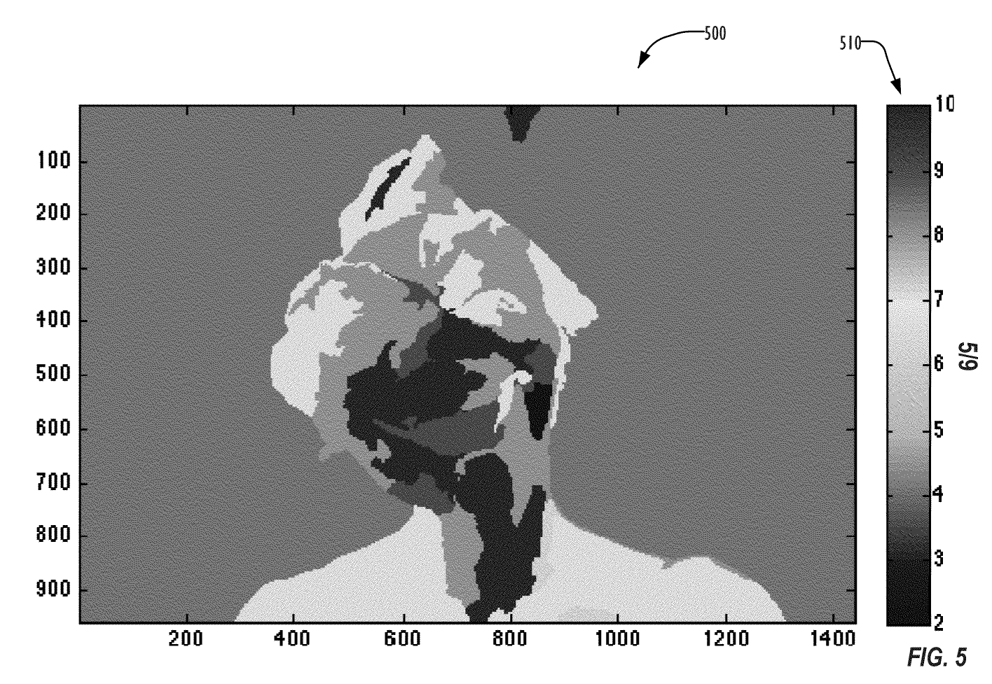

FIG. 5 is a representation of a depth map 500 created for the 3D object of FIG. 4. Recently several new technologies have been introduced that enable creating a 2D map of the three-dimensional (3D) coordinates of a scene; for example, the Microsoft Kinect® device. (“KINECT” is a registered trademark of Microsoft Corporation.) There are several different technologies at this time that can create such depth maps: time of flight, structured light, spatial phase imaging, polarization-based methods, lidar, radar, etc. Alternatively, there are techniques to create a 3D depth map from a sequence of 2D images, either captured from a single camera or from a collection of cameras, such as computed tomography or more crudely by simply capturing a sequence of 2D images with an adjustable focus camera.

Using a sequence of images that sweep through different focusing points a coarse model can be generated that separates a subject object from the background of the image. A simple binning of focus groups into near and far may be sufficient for a depth map. A pair of images, one made with flash illumination and one without shows how the flash illuminates the scene and can be used to separate foreground from background objects. In certain types of images, such as portraits, where a portion of the image is well isolated from the rest of the image, segmentation may be done based on that portion of the image. In another technique, multiple images with movement of objects in the image can be used to segment the moving objects from the non-moving objects. Any desired technique for creating a depth map may be used.

In addition, devices equipped with accelerometers and/or gyroscopes, such as the programmable device 100, can detect how an observer holds the device and can track changes in the orientation of the device. Furthermore, devices with built in cameras can detect the presence of an observer and track the orientation of the observer with respect to the device by detecting the location and orientation of the observer's face, body, eyes, gaze, gesture, etc. and track in real time how the relative position and orientation of the observer changes.

The depth map may be used to determine a number of segments at differing depths. In the example depth map 500 of FIG. 5, 9 levels (2-10) have been defined in the level index 510, allowing segmenting the object into segments associated with those levels.

When starting from a 2D image, less depth information is available. In such a scenario, segmentation may be accomplished using object recognition techniques that detect objects in the image and define segments associated with the recognized objects. Other segmentation techniques may be used as desired, including simple segmenting by color. As stated above, any segmentation technique may be used to segment the image into at least 2 layers. Although 2 layers may be used, having greater than 2 layers may improve the volumetric effect of the pseudo-3D image.

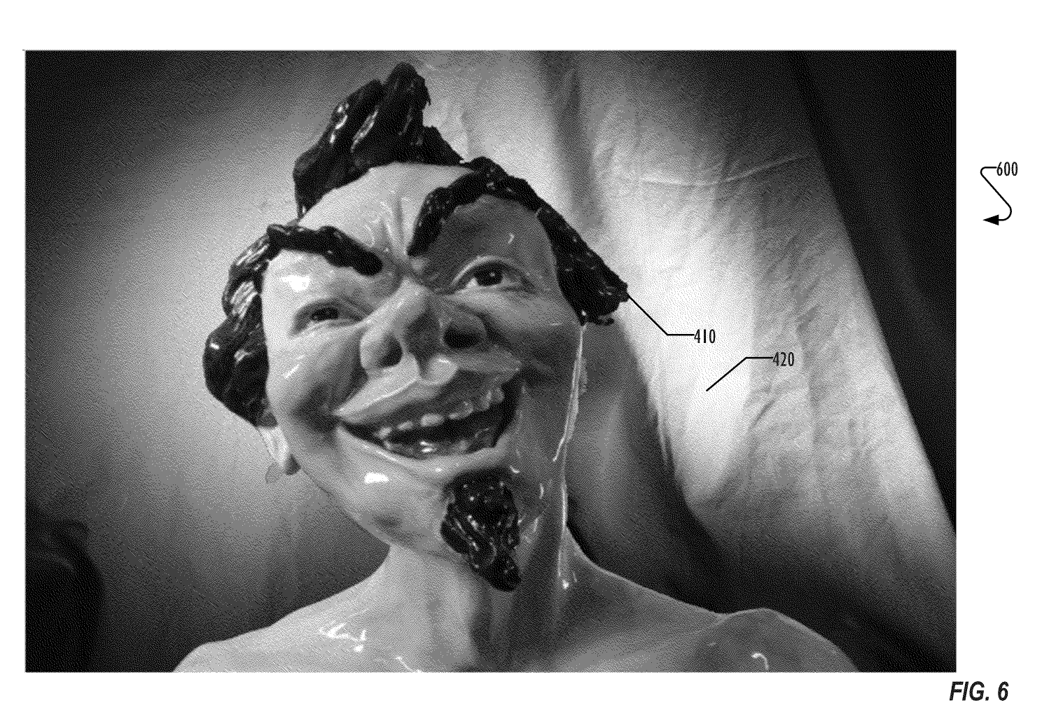

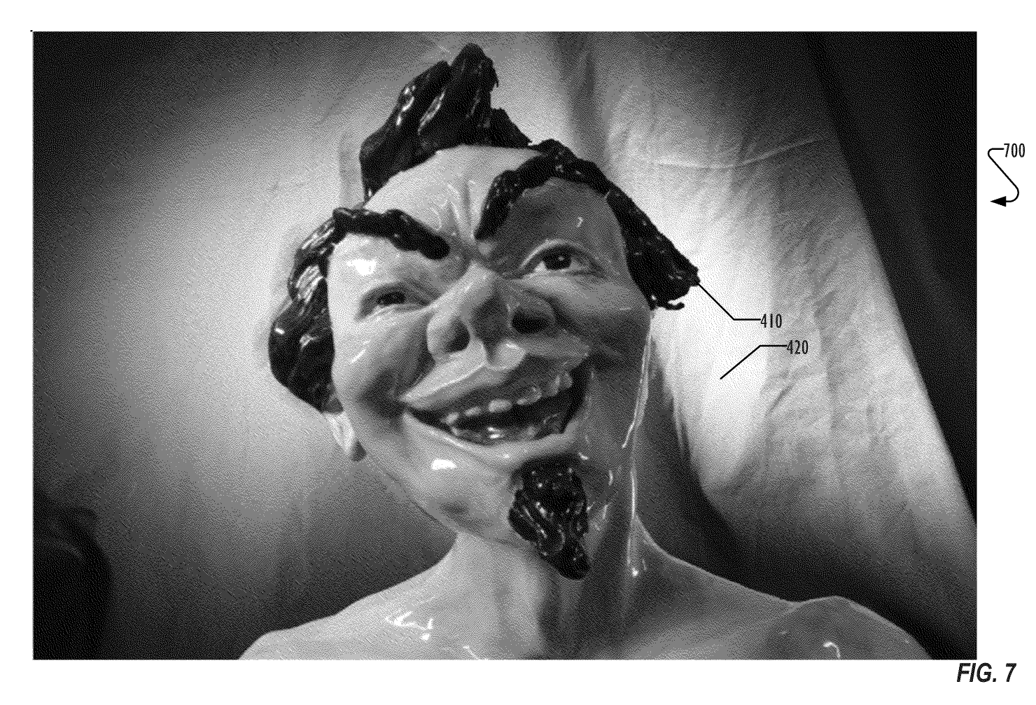

FIG. 6 is an image 600 created using a disclosed technique illustrating the 3D effect where the observer's position has shifted to the right, showing relative movement between the foreground object and the background image. Similarly, FIG. 7 is an image 700 illustrating the 3D effect where the observer's position has shifted to the left. In each example, areas of the background 420 that were occluded in the original center position image 400 are now visible because of the movement of the foreground object 410 relative to the background object 420.

FIG. 7 is a flowchart illustrating a technique 800 for generating a pseudo-3D image according to one embodiment. In block 810, a depth map is generated for the image, using any desired technique. Then in block 820, the depth map is used to segment the image into 2 or more segments. In block 830, the segments are rendered as a multilayer image. When rendering the image, the layers are arranged based on the depth map, so that the more foreground layers are layered on top of the more background layer(s), in one embodiment, to produce a pseudo-3D image that appears to bring the more foreground layers toward the observer. In another embodiment, the more background layers may be layered above the more foreground layers, to produce a pseudo-3D image that appears to move the more background layers away from the observer.

Then in block 830, the pseudo-3D image may be presented to simulate depth of field with parallax. In one embodiment, the scaling is performed corresponding to a depth ordering of the layers, with more foreground layers are scaled monotonically greater than the more background layers, so that each foreground layer is larger relative to its immediately more background layer than in the original image. In one embodiment, color grading or other color differentiation techniques may be used as desired to help the foreground objects “pop out” better. In one embodiment, blurring may be used in addition to or instead of color differentiation techniques, typically blurring background layers more than foreground layers, or making the foreground layers sharper than the background layers.

By moving the stack of layers relative to each other, the pseudo-3D image may be manipulated to show a parallax effect, such as is illustrated in FIGS. 6 and 7. Portions of the background layers that were occluded by more foreground layers may become visible as the foreground layers are translated relative to the background layers. Some embodiments may use image fill or other inpainting techniques to fill in areas of the background layers that were not visible in the original 2D image, where the relative movement exceeds the amount of occlusion produced by the increased scaling of the foreground segment. Where the foreground image is one with interior openings, such as a doughnut shape with a central hole showing the background, mere scaling may be insufficient to handle the view of the background through the foreground segment, and other fill techniques may be used. The translation may be in any direction, depending on the changed position or orientation of the observer that is to be simulated.

In some embodiments, in addition to or instead of simple translation of the foreground objects, perspective transformations, such as keystoning, may be used to simulate a 3D rotation of the pseudo-3D image.

Where the foreground segment forms an opening, e.g., a doughnut with a center hole, inpainting techniques may be used as desired to adjust the view of the background. In one embodiment, a background view through a hole may be generated as a separate background segment or incorporated as part of a background segment, so that the background viewed through the hole changes when the foreground segment is translated to produce the parallax effect.

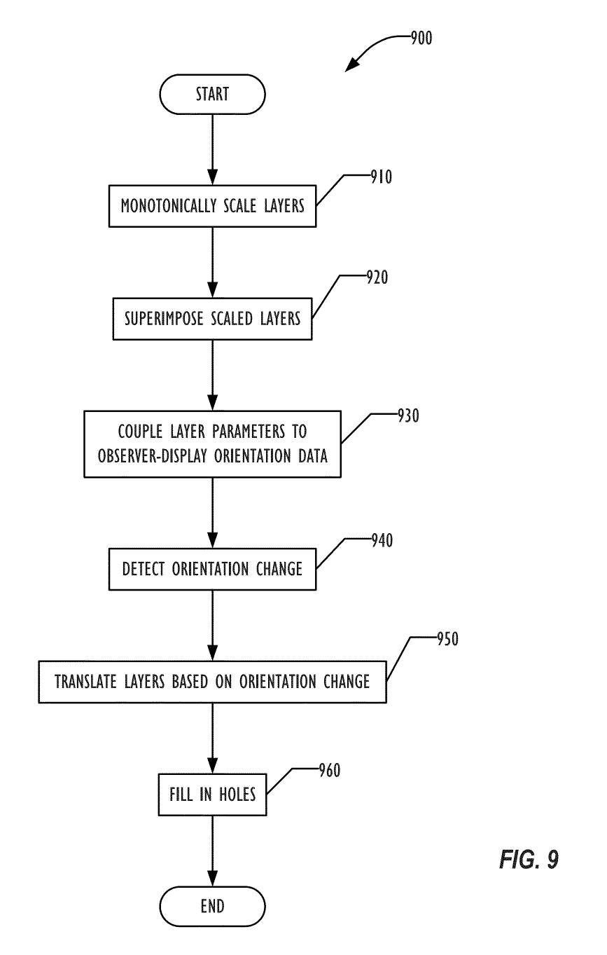

FIG. 9 is a similar flowchart of a technique 900 in which layering of segments is used to adjust the view of a pseudo-3D image based on a perceived orientation of the observer relative to the display of the programmable device. This orientation may be detected in any desired way, for example, by using a front-facing camera on the programmable device to detect the observer's orientation to the display, including changes in that orientation. In block 910, the layers of the segments created from the depth map are monotonically scaled as discussed above. In block 920, the scaled layers are superimposed, creating the pseudo-3D image. In block 930, parameters for the layers may be coupled to orientation data obtained by the programmable device to produce a parallax effect translation of the layers appropriate for that orientation, as described above.

In block 940, the programmable device may detect a change in the orientation of the observer relative to the programmable device. This may involve detection of movement of the observer, detection of movement of the programmable device, or both. For example, a programmable device laying on a static surface may detect that the observer has moved (translation in 1 or more dimensions, rotation about 1 or more axes, or both) relative to the programmable device. In another example, the programmable device may detect that the observer has moved or rotated the programmable device.

After calculating the change in point of view of the observer, in block 950 the layers may be translated to correspond to the change in relative orientation of the observer and the programmable device. In embodiments where rotational or perspective changes are applied in addition to translation, these changes may also be applied to the pseudo-3D image to simulate the view the observer would have of an actual 3D object instead of a 2D image.

In block 960, as discussed above, the programmable device may need to fill or inpaint holes in the more foreground segments to improve the 3D effect.

By using segmentation of a 2D image and modifying their relative scale according to a depth ordering, a pseudo-3D image may be created from the 2D image that allows an observer to observe parallax effects that approximate or simulate the effect of different views of a 3D object. While the effect may be subtle, the pseudo-3D effect can enhance the user experience of the programmable device.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A machine readable medium on which are stored instructions, comprising instructions that when executed cause a programmable device to:
generate a depth map corresponding to a two dimensional image;
segment the two dimensional image corresponding to the depth map into a plurality of image segments;
scale the plurality of image segments;
render the plurality of segments as a multilayer pseudo-three dimensional image; and
translate the plurality of image segments responsive to a change in a relative position or orientation of the programmable device and an observer.

2. The machine readable medium of claim 1, wherein the instructions to scale the plurality of image segments comprise instructions that when executed cause the programmable device to:
monotonically scale the plurality of segments corresponding to a depth ordering of the plurality of segments.

3. The machine readable medium of claim 1, wherein the instructions to scale the plurality of image segments comprise instructions that when executed cause the programmable device to:
monotonically scale the plurality of segments such that a more foreground segment is scaled more than a more background segment.

4. The machine readable medium of claim 1, wherein the instructions further comprise instructions that when executed cause the programmable device to:
detect a change in the relative position or orientation of the programmable device and the observer.

5. The machine readable medium of claim 1, wherein the instructions further comprise instructions that when executed cause the programmable device to:
blur background segments relative to foreground segments.

6. The machine readable medium of claim 1, wherein the instructions further comprise instructions that when executed cause the programmable device to:
color background segments relative to foreground segments.

7. The machine readable medium of claim 1, wherein the instructions that when executed cause the programmable device to translate the plurality of image segments comprise instructions that when executed cause the programmable device to:
inpaint an area of a more background segment exposed by translation of a more foreground segment.

8. The machine readable medium of claim 1, wherein the instructions that when executed cause the programmable device to segment the two dimensional image comprise instructions that when executed cause the programmable device to:
detect a hole in a more foreground segment that make a portion of a more background segment visible through the hole.

9. The machine readable medium of claim 8, wherein the instructions that when executed cause the programmable device to translate the plurality of image segments comprise instructions that when executed cause the programmable device to:
inpaint the portion of the more background segment visible through the hole corresponding to the translation of the more foreground segment.

10. A programmable device, comprising:
a programmable control unit; and
a memory coupled to the programmable control unit, wherein instructions are stored in the memory, the instructions comprising instructions that when executed cause the programmable control unit to:
generate a depth map corresponding to a two dimensional image;
segment the two dimensional image corresponding into a plurality of image segments, responsive to the depth map; and
render the plurality of segments as a multilayer pseudo-three dimensional image, wherein each of the plurality of segments is scaled relative to a previous segment of the plurality of segments.

11. The programmable device of claim 10, wherein the instructions further comprise instructions that when executed cause the programmable control unit to:
detect a change in relative position or orientation of the programmable device and an observer; and
translate the plurality of image segments in a direction corresponding to the change in relative orientation.

12. The programmable device of claim 11, wherein the instructions further comprise instructions that when executed cause the programmable control unit to:
perform a perspective transformation of the plurality of image segments corresponding to a change in the relative orientation.

13. The programmable device of claim 10, wherein the instructions that when executed cause the programmable control unit to render the plurality of segments comprise instructions that when executed cause the programmable control unit to:
modify one or more of position, scale, rotation, perspective, distortion, blur, contrast, and color characteristics of one or more of the plurality of image segments.

14. The programmable device of claim 10, wherein the plurality of image segments comprises at least three image segments.

15. A method of manipulating a two-dimensional image, comprising:
generating a depth map corresponding to a two-dimensional image by a programmable device;
segmenting the two dimensional image corresponding into a plurality of image segments, responsive to the depth map; and
rendering the plurality of segments as a multilayer pseudo-three dimensional image, wherein each of the plurality of segments is scaled relative to a previous segment of the plurality of segments.

16. The method of claim 15, further comprising:
detecting a change in relative position or orientation of the programmable device and an observer; and
translating the plurality of image segments in a direction corresponding to the change in relative orientation.

17. The method of claim 16, further comprising:
transforming the plurality of image segments corresponding to a change in the relative orientation.

18. The method of claim 16, further comprising:
rotating the plurality of image segments corresponding to the change in the relative position or orientation.

19. The method of claim 15, wherein rendering the plurality of image segments comprises:
modifying one or more of position, scale, rotation, perspective, distortion, blur, contrast, and color characteristics of one or more of the plurality of image segments.

20. The method of claim 15, wherein rendering the plurality of image segments comprises:
scaling each of the plurality of segments monotonically larger than a previous segment of the plurality of segments.
